(19) United States
(12) Patent Application Publication
(10) Pub. No.: US 2025/0139516 A1
(43) Pub. Date: May 1, 2025

(54) ACCURACY-PRESERVING DEEP MODEL COMPRESSION

(71) Applicant: Nokia Technologies Oy, Espoo (FI)

(72) Inventors: Yash GARG, Murray Hill, NJ (US); Ahmet AKYAMAC, Murray Hill, NJ (US)

(21) Appl. No.: 18/835,230

(22) PCT Filed: Feb. 2, 2023
(86) PCT No.: PCT/IB2023/050929

§ 371 Date: Aug. 1, 2024

Related U.S. Application Data
(60) Provisional application No. 63/309,036, filed on Feb. 11, 2022.

(51) Int. Cl. G06N 20/00

(52) U.S. Cl. CPC G06N 20/00

(57) ABSTRACT

Techniques described herein provide for compression of machine learning models without significant loss in model accuracy and without requiring model re-training. Compressed machine learning models may then be deployed by resource-constrained devices to improve operational efficiency and throughput. An example method includes providing input data for one or more deep learning tasks to a machine learning model having a plurality of neuronal units. The neuronal units are associated with respective parameters. The method further includes determination of respective confidence scores for the plurality of neuronal units responsive to the input data. A confidence score represents a contribution, significant, or impact of a neuronal unit with respect to the overall model output. The method further includes generating a compressed machine learning model based at least in part on removing a subset of neuronal units according to their respective confidence scores and redistributing their parameters to another subset of neuronal units.

### TECHNOLOGICAL FIELD

An example embodiment relates generally to the use of machine learning models in end device computing. More particularly, an example embodiment includes techniques for compressing machine learning models for efficient use by end devices.

### BACKGROUND

Machine learning models can include up to billions of nodes and parameters that are used to provide accurate results for different tasks including but not limited to classification, recognition, and prediction. As such, training and running machine learning models generally are very resource intensive tasks, and a machine learning model may be associated with large storage requirements.

Various functionalities of some end devices may be enhanced through the application and use of machine learning models; however, such end devices may be constrained with respect to their computational ability or throughput, their storage capabilities, their power capacity, and/or the like. Accordingly, there exist several technical challenges in the use of machine learning models locally by end devices, and generally, in the ability of end devices to feasibly and efficiently use machine learning models for various tasks.

### BRIEF SUMMARY

In general, various embodiments of the present disclosure provide apparatuses, methods, computer program products, computing devices, systems, and/or the like for compressing machine learning models for use in resource-constrained contexts, such as end devices having relatively limited computational throughput, storage capabilities power capacity, and/or the like. From a machine learning model, various embodiments provide for generation of a compressed machine learning model having no significant loss of accuracy. In particular, according to various embodiments described herein, a machine learning model is compressed based at least in part on pruning a selected subset of its neuronal units and redistributing parameters associated with the pruned neuronal units to other neuronal units. With intelligent selection of neuronal units for pruning and redistribution of parameters, a machine learning model can be compressed without significant losses in accuracy, in various examples.

Accordingly, various embodiments address various technical challenges related to the resource-intensive use of machine learning models. In one particular example scenario, a plurality of end devices may receive and/or store a pre-trained machine learning model, which can then be compressed—in accordance with various embodiments described herein—for applied use in specific tasks performed by each end device. Each end device may be configured to perform operations to locally and natively compress its machine learning model(s) and may do so using device-specific data related to some device-specific tasks. Accordingly, a machine learning model may be compressed into different configurations for different end devices for optimality in respective device-specific contexts and constraints. In this example scenario, the local model compression at the end devices further minimizes widespread distribution of device-specific data, thereby improving data security and privacy within a network of end devices.

According to one aspect of the present disclosure, an apparatus is provided that includes at least one processor and at least one memory including computer program code. The at least one memory and the computer program code are configured to, with the at least one processor, cause the apparatus to provide input data for one or more deep learning tasks to a machine learning model including a plurality of neuronal units associated with at least one respective parameter. The at least one memory and the computer program code are further configured to, with the at least one processor, cause the apparatus to determine respective confidence scores for the plurality of neuronal units responsive to the input data. The at least one memory and the computer program code are further configured to, with the at least one processor, cause the apparatus to generate a compressed machine learning model of the machine learning model based at least in part on redistributing the respective parameters associated with a first subset of the neuronal units to a second subset of the neuronal units. The first subset of the neuronal units is selected according to their respective confidence scores.

In various embodiments, the compressed machine learning model is generated further based at least in part on removing the first subset of the neuronal units from the machine learning model. In various embodiments, a magnitude by which the respective parameters associated with the first subset are redistributed to the neuronal units of the second subset is based at least in part on the respective parameters associated with the second subset. In various embodiments, the first subset includes neuronal units selected from one or more hidden layers of the machine learning model and having confidence scores satisfying a configurable threshold. In various embodiments, the configurable threshold is configured based at least in part on an amount of computing resources associated with the at least one processor. In various embodiments, the second subset includes at least one neuronal unit belonging to a hidden layer of the machine learning model to which at least one neuronal unit of the first subset also belongs.

In various embodiments, the at least one memory and the computer program code are configured to, with the at least one processor, cause the apparatus to determine the respective confidence scores for the plurality of the neuronal units by, for a neuronal unit belonging to a hidden layer of the machine learning model, identifying an inbound region and an outbound region for the neuronal unit. The inbound region maps to the input layer of the machine learning model, and the outbound region maps to the output layer of the machine learning model. The at least one memory and the computer program code are configured to, with the at least one processor, cause the apparatus to determine the respective confidence scores for the plurality of the neuronal units further by, for the neuronal unit belonging to the hidden layer, determining an inbound confidence score for the neuronal unit using the inbound region and determining an outbound confidence score for the neuronal unit using the outbound region. The at least one memory and the computer program code are configured to, with the at least one processor, cause the apparatus to determine the respective confidence scores for the plurality of the neuronal units further by, for the neuronal unit belonging to the hidden layer, using the inbound confidence score and the outbound confidence score to form a confidence score for the neuronal unit.

In various embodiments, the inbound confidence score is determined according to the respective parameters associated with neuronal units within the inbound region and respective confidence scores for neuronal units within the input layer, and the outbound confidence score is determined according to the respective parameters associated with neuronal units within the outbound region and respective confidence scores for neuronal units within the output layer.

In various embodiments, the at least one memory and the computer program code are configured to, with the at least one processor, cause the apparatus to determine the respective confidence scores for the plurality of neuronal units by initializing the confidence score for a plurality of neuronal units belonging to an input layer of the machine learning model to a constant value, and determining the confidence score for a plurality of neuronal units belonging to an output layer of the machine learning model based at least in part on performing infinite feature selection on a plurality of values at the plurality of neuronal units belonging to the output layer in response to the input data.

In various embodiments, the input data includes data generated by the apparatus. In various embodiments, the at least one memory and the computer program code are further configured to, with the at least one processor, cause the apparatus to deploy the compressed machine learning model for use in performing the one or more deep learning tasks.

In various embodiments, the machine learning model is pre-trained. In some other various embodiments, the machine learning model is un-trained or at least partially trained. In some other various embodiments, the machine learning model may be at least partially pruned and/or compressed. In various embodiments, the input data is training data for the machine learning model. In various embodiments, the at least one respective parameter associated with a neuronal unit includes a weight for the neuronal unit and/or a bias for the neuronal unit.

According to a further aspect of the present disclosure, a method is provided that includes providing input data for one or more deep learning tasks to a machine learning model including a plurality of neuronal units associated with at least one respective parameter. The method further includes determining respective confidence scores for the plurality of neuronal units responsive to the input data. The method further includes generating a compressed machine learning model of the machine learning model based at least in part on redistributing the respective parameters associated with a first subset of the neuronal units to a second subset of the neuronal units. The first subset of the neuronal units is selected according to their respective confidence scores.

In various embodiments, the compressed machine learning model is generated further based at least in part on removing the first subset of the neuronal units from the machine learning model. In various embodiments, a magnitude by which the respective parameters associated with the first subset are redistributed to the neuronal units of the second subset is based at least in part on the respective parameters associated with the second subset. In various embodiments, the first subset includes neuronal units selected from one or more hidden layers of the machine learning model and having confidence scores satisfying a configurable threshold. In various embodiments, the configurable threshold is configured based at least in part on an amount of computing resources associated with the at least one processor. In various embodiments, the second subset includes at least one neuronal unit belonging to a hidden layer of the machine learning model to which at least one neuronal unit of the first subset also belongs.

In various embodiments, the determination of the respective confidence scores for the plurality of the neuronal units includes, for a neuronal unit belonging to a hidden layer of the machine learning model, identifying an inbound region and an outbound region for the neuronal unit. The inbound region maps to the input layer of the machine learning model and the outbound region maps to the output layer of the machine learning model. The determination of the respective confidence scores for the plurality of the neuronal units further includes, for the neuronal unit belonging to the hidden layer of the machine learning model, determining an inbound confidence score for the neuronal unit using the inbound region and determining an outbound confidence score for the neuronal unit using the outbound region. The determination of the respective confidence scores for the plurality of the neuronal units includes, for the neuronal unit belonging to the hidden layer of the machine learning model, using the inbound confidence score and the outbound confidence score to form a confidence score for the neuronal unit.

In various embodiments, the inbound confidence score is determined according to the respective parameters associated with neuronal units within the inbound region and respective confidence scores for neuronal units within the input layer, and the outbound confidence score is determined according to the respective parameters associated with neuronal units within the outbound region and respective confidence scores for neuronal units within the output layer.

In various embodiments, the determination of the respective confidence scores for the plurality of the neuronal units includes initializing the confidence score for a plurality of neuronal units belonging to an input layer of the machine learning model to a constant value. In various embodiments, the determination of the respective confidence scores for the plurality of the neuronal units further includes determining the confidence score for a plurality of neuronal units belonging to an output layer of the machine learning model based at least in part on generating a discrimination output for a plurality of values at the plurality of neuronal units belonging to the output layer in response to the input data.

In various embodiments, the input data includes device-specific data. In various embodiments, the method further includes deploying the compressed machine learning model for use in performing the one or more deep learning tasks. In various embodiments, the machine learning model is pre-trained. In various embodiments, the machine learning model is un-trained, and the input data is training data for the machine learning model. In various embodiments, the at least one respective parameter associated with a neuronal unit includes a weight for the neuronal unit and/or a bias for the neuronal unit.

According to yet another aspect of the present disclosure, a computer program product including a non-transitory computer readable storage medium having program code portions stored thereon is provided. The program code portions are configured, upon execution, to provide input data for one or more deep learning tasks to a machine learning model including a plurality of neuronal units associated with at least one respective parameter. The program code portions are further configured, upon execution, to determine respective confidence scores for the plurality of neuronal units responsive to the input data. The program code portions are further configured, upon execution, to generate a compressed machine learning model of the machine learning model based at least in part on redistributing the respective parameters associated with a first subset of the neuronal units to a second subset of the neuronal units. The first subset of the neuronal units are selected according to their respective confidence scores.

In various embodiments, the compressed machine learning model is generated further based at least in part on removing the first subset of the neuronal units from the machine learning model. In various embodiments, a magnitude by which the respective parameters associated with the first subset are redistributed to the neuronal units of the second subset is based at least in part on the respective parameters associated with the second subset. In various embodiments, the first subset includes neuronal units selected from one or more hidden layers of the machine learning model and having confidence scores satisfying a configurable threshold. In various embodiments, the configurable threshold is configured based at least in part on an amount of computing resources associated with the at least one processor. In various embodiments, the second subset includes at least one neuronal unit belonging to a hidden layer of the machine learning model to which at least one neuronal unit of the first subset also belongs.

In various embodiments, the program code portions configured to determine the respective confidence scores for the plurality of the neuronal units include, for a neuronal unit belonging to a hidden layer of the machine learning model, program code portions configured to identify an inbound region and an outbound region for the neuronal unit. The inbound region maps to the input layer of the machine learning model and the outbound region maps to the output layer of the machine learning model. The program code portions configured to determine the respective confidence scores for the plurality of the neuronal units further include, for the neuronal unit belonging to the hidden layer, program code portions configured to determine an inbound confidence score for the neuronal unit using the inbound region and determine an outbound confidence score for the neuronal unit using the outbound region. The program code portions configured to determine the respective confidence scores for the plurality of the neuronal units further include, for the neuronal unit belonging to the hidden layer, program code portions configured to use the inbound confidence score and the outbound confidence score to form a confidence score for the neuronal unit.

In various embodiments, the inbound confidence score is determined according to the respective parameters associated with neuronal units within the inbound region and respective confidence scores for neuronal units within the input layer, and the outbound confidence score is determined according to the respective parameters associated with neuronal units within the outbound region and respective confidence scores for neuronal units within the output layer.

In various embodiments, the program code portions configured to determine the respective confidence scores for the plurality of the neuronal units include program code portions configured to initialize the confidence score for a plurality of neuronal units belonging to an input layer of the machine learning model to a constant value. The program code portions configured to determine the respective confidence scores for the plurality of the neuronal units further include program code portions configured to determine the confidence score for a plurality of neuronal units belonging to an output layer of the machine learning model based at least in part on generating a discrimination output for a plurality of values at the plurality of neuronal units belonging to the output layer in response to the input data.

In various embodiments, the input data includes device-specific data. In various embodiments, the program code portions are further configured upon execution, to cause at least one processor to deploy the compressed machine learning model for use in performing the one or more deep learning tasks. In various embodiments, the machine learning model is pre-trained. In various embodiments, the machine learning model is un-trained, and the input data is training data for the machine learning model. In various embodiments, the at least one respective parameter associated with a neuronal unit includes a weight for the neuronal unit and/or a bias for the neuronal unit.

According to another aspect of the present disclosure, an apparatus is provided that includes means for providing input data for one or more deep learning tasks to a machine learning model including a plurality of neuronal units associated with at least one respective parameter. The apparatus further includes means for determining respective confidence scores for the plurality of neuronal units responsive to the input data. The apparatus further includes means for generating a compressed machine learning model of the machine learning model based at least in part on redistributing the respective parameters associated with a first subset of the neuronal units to a second subset of the neuronal units. The first subset of the neuronal units is selected according to their respective confidence scores.

In various embodiments, the means for generating the compressed machine learning model include means for removing the first subset of the neuronal units from the machine learning model. In various embodiments, a magnitude by which the respective parameters associated with the first subset are redistributed to the neuronal units of the second subset is based at least in part on the respective parameters associated with the second subset. In various embodiments, the first subset includes neuronal units selected from one or more hidden layers of the machine learning model and having confidence scores satisfying a configurable threshold. In various embodiments, the configurable threshold is configured based at least in part on an amount of computing resources associated with the at least one processor. In various embodiments, the second subset includes at least one neuronal unit belonging to a hidden layer of the machine learning model to which at least one neuronal unit of the first subset also belongs.

In various embodiments, the means for determining of the respective confidence scores for the plurality of the neuronal units includes, for a neuronal unit belonging to a hidden layer of the machine learning model, means for identifying an inbound region and an outbound region for the neuronal unit. The inbound region maps to the input layer of the machine learning model, and the outbound region maps to the output layer of the machine learning model. The means for determining of the respective confidence scores for the plurality of the neuronal units further includes, for the neuronal unit belonging to the hidden layer, means for determining an inbound confidence score for the neuronal unit using the inbound region and determining an outbound confidence score for the neuronal unit using the outbound region. The means for determining of the respective confidence scores for the plurality of the neuronal units further includes, for the neuronal unit belonging to the hidden layer, means for using the inbound confidence score and the outbound confidence score to form a confidence score for the neuronal unit.

In various embodiments, the inbound confidence score is determined according to the respective parameters associated with neuronal units within the inbound region and respective confidence scores for neuronal units within the input layer, and the outbound confidence score is determined according to the respective parameters associated with neuronal units within the outbound region and respective confidence scores for neuronal units within the output layer.

In various embodiments, the means for determining of the respective confidence scores for the plurality of the neuronal units include means for initializing the confidence score for a plurality of neuronal units belonging to an input layer of the machine learning model to a constant value. The means for determining of the respective confidence scores for the plurality of the neuronal units further include means for determining the confidence score for a plurality of neuronal units belonging to an output layer of the machine learning model based at least in part on generating a discrimination output for a plurality of values at the plurality of neuronal units belonging to the output layer in response to the input data.

In various embodiments, the input data includes data generated by the apparatus. In various embodiments, the apparatus further includes means for deploying the compressed machine learning model for use in performing the one or more deep learning tasks. In various embodiments, the machine learning model is pre-trained. In various embodiments, the machine learning model is un-trained, and the input data is training data for the machine learning model. In various embodiments, the at least one respective parameter associated with a neuronal unit includes a weight for the neuronal unit and/or a bias for the neuronal unit.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings.

FIG. 1 is a diagram of an example system architecture in accordance with various embodiments described herein.

FIG. 2 is a block diagram of an example apparatus configured to perform operations for compression of a machine learning model, in accordance with various embodiments described herein.

FIG. 3 provides a diagram illustrating an example machine learning model that can be compressed for improved computational efficiency, in accordance with various embodiments of the present disclosure.

FIG. 4 provides a flowchart describing example operations performed for compressing a machine learning model, in accordance with various embodiments.

FIG. 5 provides a flowchart describing example operations performed for selecting certain components of the machine learning model for compression, in accordance with various embodiments of the present disclosure.

FIG. 6 provides a diagram describing selection of certain components of the machine learning model for compression, in accordance with various embodiments of the present disclosure.

FIG. 7A provides a diagram illustrating parameter redistribution that is performed during model compression, in accordance with various embodiments of the present disclosure.

FIG. 7B provides a diagram illustrating parameter redistribution that is performed during model compression, in accordance with various embodiments of the present disclosure.

### DETAILED DESCRIPTION

Example embodiments of the present disclosure will now be described more fully hereinafter with reference to the accompanying drawings, in which some, but not all, various example embodiments of the present disclosure are shown. Indeed, the various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in the at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal serial bus (USB) flash drives), computer system memory or random-access memory (such as, dynamic random access memory (DRAM), static random access memory (SRAM), extended data out random access memory (EDO RAM)), and/or the like.

Additionally, as used herein, the term ‘circuitry’ or a processing circuitry refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

With the implementation of machine learning and deep learning in various tasks comes high computational resource requirements. That is, training and running machine learning models are significantly resource-intensive. One significant contributing factor to these high resource requirements associated with machine learning models is the size of the models themselves. Each neuronal unit, such as a neuron or a node, of a machine learning model is itself associated with one or more parameters and represents at least one operation or function to be processed when running the model. Thus, a machine learning model may then require large amounts of storage capacity as well as large amount of computational bandwidth, power, and throughput to process the large number of nodes to successfully and reasonable complete its tasks.

In various examples, implementing and running machine learning models to generate insights (e.g., predictive data, classifications, and/or the like) on ubiquitous and accessible end devices enables numerous opportunities for specialized tasks, functions, and applications that can rapidly provide important knowledge locally. Such end devices may include, for instance, mobile phones, mobile communication devices, tablets, smart home devices, laptops, televisions, OTT (over the top) devices, cameras, Internet-of-Things (IoT) devices, sensors, smart watches, household appliances, and accessories, and/or the like, or any combination thereof. Operation of such tasks, functions, and applications-using machine learning models-locally at end devices may further be desirable with respect to scalability and security reasons. However, use of machine learning models at a number of different end devices within a system architecture may further exacerbate, in various examples, the aforementioned technical issues related to the high resource requirements associated with machine learning models generally. For instance, end devices may be relatively resource-constrained.

Edge computing, distributed computing, and cloud computing have been introduced in the field generally as architectures within which intensive processes may be performed or computed remotely from the end devices or in a distributed manner. However, such computing architecture may rely upon and require high network bandwidth and availability for the transmission of data between different devices and entities, thereby increasing load and strain on network infrastructure.

Accordingly, various embodiments of the present disclosure provide for compression of machine learning models such that compressed machine learning models may be used and implemented also on resource-constrained devices, such as end devices. In various embodiments, compression of a machine learning model may be performed locally at an end device using its device-specific data. As such, a machine learning model may be compressed in a manner that is specific to an end device and its machine learning-based tasks. Model compression may then be scalable to a large number of end devices within an architecture, in various examples. In one or more example embodiments, a machine learning model may be compressed during its training such that compressed versions of the machine learning model may be distributed and deployed (e.g., implemented for use in one or more automated pipelines and/or tasks).

In accordance with various example embodiments described herein, compression of a machine learning model may include selecting neuronal units of the machine learning model for pruning or removal, removing such neuronal units, and redistributing parameters associated with such neuronal units to other neuronal units. Various embodiments of model compression described herein preserve the accuracy of the machine learning model due in part to the particular selection of neuronal units for removal and the redistribution of neuronal unit parameters. That is, in various example embodiments, neuronal units that have relatively lower impact on the generated model output for a specific task (e.g., a device-specific task using device-specific data) may be selected for removal. Even further, parameters for the removed neuronal units may be redistributed to nearby neuronal units such that the overall accuracy level of the machine learning model is preserved, or at least minimizing loss of the accuracy level, through compression.

With at least these accuracy-preserving features of model compression, various embodiments of the present disclosure may be advantageous with respect to operational efficiency compared to existing model pruning approaches. In some examples, existing model pruning approaches require re-training of a machine learning model after its compression in order to maintain acceptable levels of accuracy. This may be prohibitively expensive, as a compressed model would be re-trained for each individual end device, in some example architectures. Even further, in some examples, re-training a compressed model may not guarantee that model accuracy is recovered, maintained, or improved. Thus, according to various embodiments described herein, machine learning models are compressed without necessarily requiring re-training and without a significant loss of accuracy, thereby improving end-to-end operational efficiency.

One or more example embodiments described herein provide further technical effects in improving data security and/or privacy among multiple devices in a network and/or architecture. In various examples, preservation of data privacy is achieved by exposing only end insights in a federated model rather than user or device level data directly in a centralized model. Individualized and device-specific model compression using device-specific and local data minimizes widespread of distribution of data, as required in model compression at a centralized system. Thus, for example, various embodiments provide improved data security and/or privacy and reduced network resource usage, among other technical advantages.

An example embodiment of the present disclosure includes a method that may be performed to generate a compressed machine learning model. In various embodiments, the method may include providing input data for one or more deep learning tasks to a machine learning model, which includes a plurality of neuronal units each associated with at least one parameter. In various embodiments, the method may further include determining respective confidence scores for the plurality of neuronal units responsive to the input data. In various embodiments, the method may further include generating a compressed machine learning model of the machine learning model based at least in part on redistributing the respective parameters associated with a first subset of the neuronal units to a second subset of the neuronal units. The first subset of the neuronal units may be selected according to their respective confidence scores.

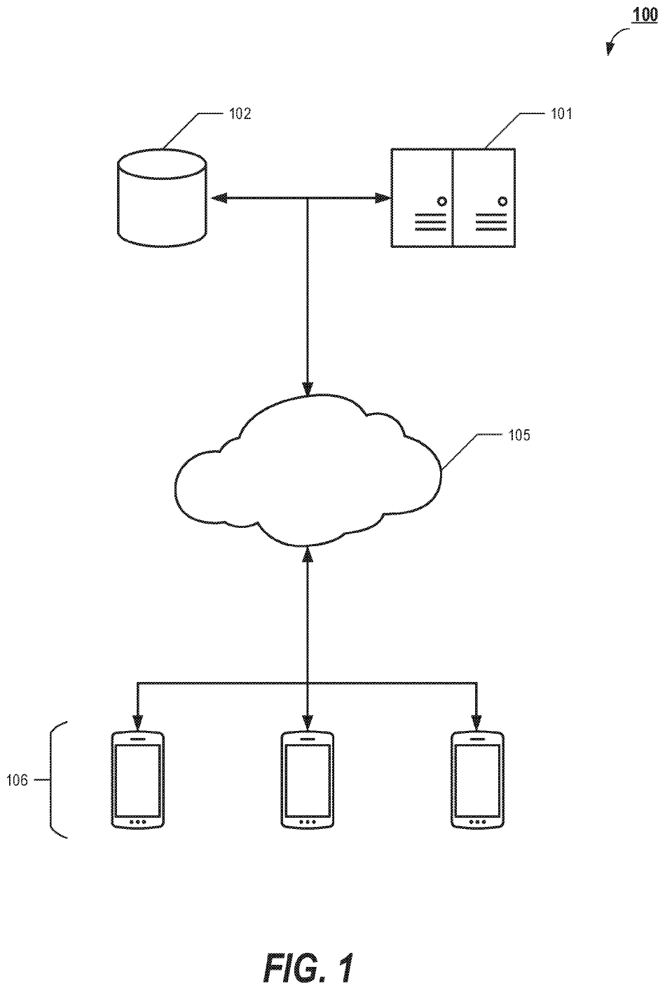

Referring now to FIG. 1, an example system architecture 100 within which various embodiments disclosed herein may operate is illustrated. It will be appreciated that the system architecture 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of such a system, numerous other configurations may also be employed.

As discussed, various embodiments of the present disclosure are directed to compressing a machine learning model while maintaining its accuracy, and a compressed machine learning model may be generated and deployed (e.g., implemented, automated, used) for one or more deep learning tasks. FIG. 1 illustrates the system architecture 100 within which a compressed machine learning model may be generated and deployed to perform deep learning tasks. As illustrated, FIG. 1 includes a resource-dedicated system 101 and one or more resource-constrained devices 106. For example, the resource-constrained devices 106 include mobile phones, mobile communication devices, tablets, smart watches, IoT (Internet-of-Things) sensors, IoT devices, sensors, smart home devices, laptops, televisions, OTT (over the top) devices, cameras, household appliances and accessories, network routers, network access points, vehicles, drones, and/or the like, or any combination thereof. In various example embodiments, the one or more resource-constrained devices 106 may deploy a machine learning model, such as a compressed machine learning model, for use in their respective and/or device-specific tasks, and in some examples, the compressed machine learning model may be generated locally at a respective end device 106. In alternative examples, the compressed machine learning model used by the resource-constrained devices 106 may be generated remotely at the resource-dedicated system 101 and subsequently provided to the resource-constrained devices 106. For instance, the resource-dedicated system 101 may be configured to compress a machine learning model during or after training the machine learning model.

The model compression performed at the resource-constrained devices 106 and/or the resource-dedicated system 101 may be enabled by a data repository 102 which may be used to store pre-trained machine learning models to be compressed, un-trained machine learning models to be trained and compressed, compressed machine learning models to be deployed and/or distributed, training data and/or input data for various machine learning models, and/or the like. The resource-constrained devices 106 and/or the resource-dedicated system 101 may be configured to communicate with the data repository 102. In one or more example embodiments, a data repository 102 may store publicly available (e.g., “open-source”) machine learning models, and the resource-constrained devices 106 and/or the resource-dedicated system 101 may access the data repository 102 (e.g., via a data network) to retrieve such machine learning models for compression.

As discussed, the resource-constrained devices 106 may be exemplified in some embodiments by end devices that may have functional components of a relatively smaller scale. In various embodiments, the resource-constrained devices 106 may include systems, computing entities, apparatuses, and/or the like that may have defined resource constraints for one or more deep learning tasks involving machine learning models. Thus, for instance, while a resource-constrained device 106 may include resource constraints defined according to hardware limitations, a resource-constrained device 106 may include resource constraints that may be defined “on-demand”, arbitrarily, and/or the like, such as to improve efficiency (e.g., to enable or facilitate parallel processing, to generally streamline computation). As used herein, the resource-constrained device 106 may refer to a device at which a compressed machine learning model may be deployed, such as to perform tasks in respect of resource constraints, and in some example embodiments, the resource-constrained device 106 may perform the model compression itself.

Meanwhile, in the context of the system architecture 100 illustrated in FIG. 1, a resource-dedicated system 101 may refer to a system where a compressed machine learning model may not be deployed, although, in some examples, the resource-dedicated system 101 may not be precluded or restricted from using a compressed machine learning model itself. In various embodiments, the resource-dedicated system 101 may serve as a centralized system that may communicate to a plurality of resource-constrained devices 106, or end devices, and may provide a machine learning model to the resource-constrained devices 106 for compression, in some examples. For instance, the resource-dedicated system 101 may train or pre-train the machine learning model and may distribute the pre-trained machine learning model to the resource-constrained devices 106, where model compression may be performed. As a further example, the resource-dedicated system 101 may perform model compression at least in part and may provide an at least partially compressed machine learning model to the resource-constrained devices 106.

In various embodiments, model compression may be performed by the resource-constrained device 106 with a machine learning model originating from the resource-dedicated system 101. For instance, the resource-dedicated system 101 may transmit the machine learning model (e.g., a pre-trained machine learning model) to one or more resource-constrained devices 106 at some point before compression. Alternatively, the resource-constrained device 106 may be configured with a natively residing machine learning model that is then compressed through execution of example operations described herein. For example, the resource-constrained device 106 may be pre-loaded, manufactured, shipped, programmed, and/or the like with one or more machine learning models that can be later compressed, for example, based on data that originates or is generated in the resource-constrained device 106.

As illustrated in FIG. 1, the resource-dedicated system 101, the data repository 102, and the one or more resource-constrained devices 106 may communicate with each other via a communication network 105. For instance, in one or more example embodiments, the resource-dedicated system 101 provides, or transmits via the communication network 105, a pre-trained machine learning model to the resource-constrained devices 106, and upon receipt via the communication network 105, the resource-constrained devices 106 may compress the pre-trained machine learning model individually and specific to their respective and/or device-specific tasks, e.g., with device-specific data and/or device-created data. In another instance, in one or more example embodiments, the resource-dedicated system 101 may at least partially compress a pre-trained machine learning model and may transmit via the communication network 105 the at least partially compressed and pre-trained machine learning model to the resource-constrained devices 106. The resource-constrained devices 106 may be configured to communicate with one another via the communication network 105 and may do so to share data comprising model outputs from compressed machine learning models and/or structures of the compressed machine learning models, for example. Similarly, the resource-constrained devices 106 may communicate with the resource-dedicated system 101 and the data repository 102 via the communication network 105, for example, to provide training data and/or input data for a machine learning model.

The communication network 105 may include any wired or wireless communication network including, for example, a wired or wireless local area network (LAN), personal area network (PAN), metropolitan area network (MAN), wide area network (WAN), short-range wireless communication network, or the like, as well as any hardware, software and/or firmware required to implement the network (such as network routers and/or the like). For example, the communication network 105 may include a radio access architecture based, for example, at least in part on a mobile telecommunications system, such as long term evolution (LTE, E-UTRA), long term evolution advanced (LTE Advanced, LTE-A), new radio (NR, 5G (5th Generation) or any further generation), universal mobile telecommunications system (UMTS) radio access network (UTRAN or E-UTRAN), or the wireless local area network, such as an 802.11, 802.16, 802.20, WiMax network, or the short-range wireless technology, such as Bluetooth®, UWB (ultra-wide band), Thread™ and/or the like.

In various embodiments, the communication network 105 includes a new radio or 5G network (or any new further generation network) enabling sidelink communications, in which the resource-constrained devices 106 and/or the resource-dedicated system 101 may communicate with each other directly without requiring relaying of data through a radio access network. In one example, at least some of the resource-constrained devices 106 may communicate with each other via the sidelink communications, such as for IoT applications. In such embodiments, the resource-constrained devices 106 and/or the resource-dedicated system 101 may create their own ad hoc network for communication without a radio access network acting as an intermediary. As such, communication between the resource-constrained devices 106 and/or the resource-dedicated system 101 may be improved with increased efficiency and speed.

In various example embodiments, the communication network 105 may be configured for multi-access edge computing (MEC) in accordance with 5G, enabling analytics and knowledge generation to occur at the source of the data. Accordingly, in some examples, resources, such the resource-constrained devices 106, that may not be continuously connected to a network, such as laptops, smartphones, tablets and sensors may be leveraged. MEC provides a distributed computing environment for application and service hosting and has the ability to store and process content in close proximity to cellular subscribers for faster response time. Generally, edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (e.g., autonomous vehicles, traffic safety, real-time analytics, time-critical control, healthcare applications), each of which may be applied in various embodiments described herein.

Accordingly, various embodiments can be applied to real-world applications to enjoy at least various technical effects described herein. In one example real-world application, model compression can be used to provide technical advantages in enterprise automation and/or robotics. A robot or a robotic apparatus 106, for example, an autonomous vehicle, robot or drone, may be limited to a physical environment (e.g., geo-fenced) and may be trained for a specific task or function, e.g., to identify a wide spectrum of scenarios within its physical environment and to navigate in the environment. The physical environment can be, for example, a factory and/or warehouse, a road network, an agricultural field, a forest, and/or the like. Parameters that are not relevant or do not significantly contribute to the robot's functions, such as an object detection, navigation and/or movement and/or the like, within its physical environment may be pruned from a machine learning model used by the robot, such that the robot may perform various functions with improved efficiency. In general, a deployment of a compressed machine learning model on a robot may improve model inference time and reduce robot response latency.

Further, the compressed machine learning model may need less computational resources, such as processing power and/or memory size, and therefore, related hardware resources may be less expensive than in case of an unpruned/uncompressed machine learning model. In accordance with further various example embodiments, such as in case of an object recognition, an initial model may be trained in a centralized manner (e.g. by a federated or distributed learning manner), e.g. by a resource-dedicated system 101, with general training data (e.g. CIFAR-100 or data that is collected via the federated or distributed learning manner) from a data repository 102, whereafter, the initial model can be downloaded by various devices 106 (e.g. the devices that have participated the federated or distributed learning). After a device 106 has obtained (e.g., downloaded) the initial model, the device can prune/compress the model with its own device specific data as further training data, that it has (or its peer device) collected and stored, and that structurally matches the general training data, as is further described below in various example embodiments. The device specific data, e.g. collected/stored in its specific physical environment, may comprise a smaller number of objects than was used in the initial model training. In further examples, the device 106 may use the initial model collect and store data in its specific work/function environment, such as the warehouse or the road network, and use the collected/stored data as a device specific training data to further prune/compress the initial model.

In another example real-world application, a model compression is applied in the user device 106 for any user specific use case and/or application, for example, to help physically impaired persons, such as object recognition for visually-impaired user, or speech recognition to help a caregiver to understand a person having aphasia. Visually impaired users may interact with a relatively static set of given objects, and thus, a machine learning model for object recognition and classification can be specifically curated for a set of objects specific to each visually impaired user. In accordance with various example embodiments described herein, a machine learning model may be curated and compressed in different manners for different users for recognition and classification of user-specific tasks and/or objects, and parameters of the machine learning model that are not significant with regard to a corresponding use case, e.g. user's user-specific objects, can be removed to conserve resources.

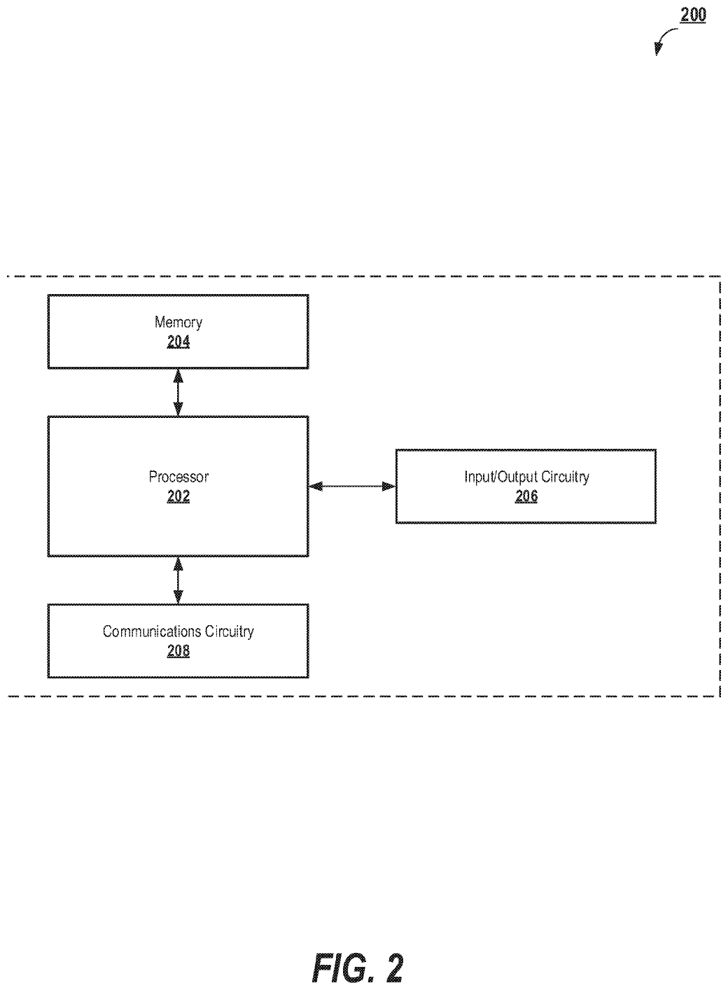

Referring now to FIG. 2, an apparatus 200 is illustrated. In various example embodiments, the apparatus 200 may include means for performing model compression to generate a compressed machine learning model for deep learning tasks. As illustrated, the apparatus 200 may include one or more processors 202, one or more memories 204, one or more input/output circuitries 206, and one or more communications circuitries 208. The apparatus 200 may be configured to execute the operations described herein. Although these components are described with respect to functional limitations, it should be understood that the particular implementations include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In accordance with various example embodiments described herein, the apparatus 200 may be embodied in a resource-constrained device 106 or an end device such as a mobile phone. In such embodiments, the apparatus 200 may be associated with relatively lower resource constraints with respect to its processor 202, memory 204, communications circuitry 208, and/or the like, and thus, the apparatus 200 may be somewhat limited in its ability to implement and use a non-compressed machine learning model to complete deep learning tasks. As such, the apparatus 200 may execute example operations described herein to generate a compressed machine learning model that may be more feasibly deployed by the apparatus 200 for its deep learning tasks. As discussed herein, the apparatus 200 may be configured to compress a machine learning model to particularly align with its own resource amounts; that is, model compression may be specific to different apparatuses.

In accordance with various example embodiments described herein, the apparatus 200 may be embodied by a resource-dedicated system 101, which may be associated with relatively higher resource constraints with respect to its functional components (e.g., processor 202, memory 204, communications circuitry 208, and/or the like) compared to resource-constrained devices 106. In such examples, the resource-dedicated system 101 may be configured to execute example operations described herein to perform model compression, and may do so while training a machine learning model, before distributing a machine learning model to end devices, and/or the like. Thus, while model compression results in a compressed machine learning model for deployment at a resource-constrained device 106, model compression may itself be performed at another entity not necessarily associated with resource constraints, such as the resource-dedicated system 101. Further, while model compression may be intended to provide technical advantages at resource-constrained devices 106, compressed machine learning models may also be deployed at resource-dedicated systems 101 to enjoy similar technical advantages.

In various example embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with an example embodiment disclosed herein.

The processor 202 may be embodied in a number of different ways and may, for example, include one or more processing devices configured to perform independently. In some embodiments, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In various example embodiments, the processor 202 may be configured to execute instructions stored in the memory 204 and/or circuitry otherwise accessible to the processor 202, such as interactions for various operations for compressing a machine learning model for more efficient deployment and use in deep learning tasks. In some embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may configure the processor 202 to perform the algorithms and/or operations described herein when the instructions are executed.

In various example embodiments, the apparatus 200 may include input/output circuitry 206 that may, in turn, be in communication with processor 202 to provide output to a user and/or other entity and, in some embodiments, to receive an indication of an input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

In various example embodiments, the apparatus 200 may include one or more sensors, for example, a positioning sensor (such as a global navigation satellite system (GNSS) sensor), accelerometer, an inertial measurement unit (IMU), a camera sensor, a microphone, a heart rate sensor, an electrocardiogram sensor, a blood pressure sensor, a blood glucose monitoring sensor, a blood oxygen sensor, a radar, a LiDAR (light detection and ranging), a proximity sensor, a thermometer, a barometer, an altimeter, or the like. Measurement data from any combinations of the sensors can be used as an input data for training a machine learning model, compressing a machine learning model, and/or inferencing any trained compressed or uncompressed machine learning model.

The communications circuitry 208 may be any means such as a device or circuitry embodied in either hardware or a combination of hardware, firmware and/or software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae. In certain example embodiments, communications circuitry 208 comprises circuitry configured for communication via LTE networks and/or circuitry configured for communication via new radio (e.g., NR, 5G) networks, in various embodiments.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

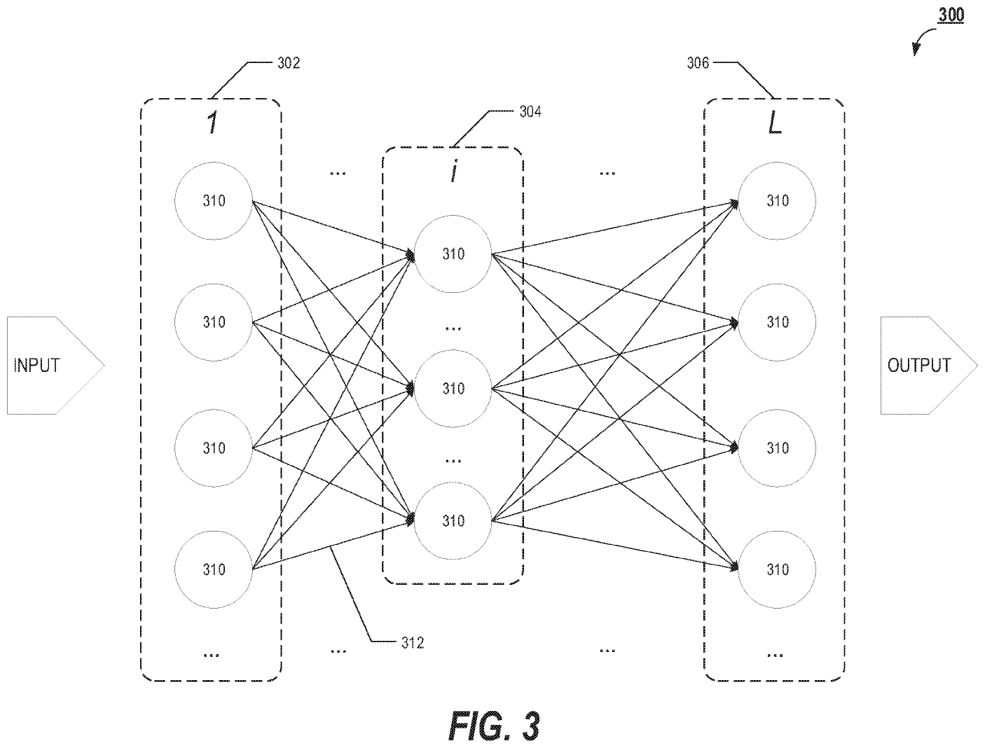

As discussed, various example embodiments are directed to compressing a machine learning model while preserving accuracy and without reliance on re-training. FIG. 3 illustrates an example of a machine learning model 300 that may be compressed in accordance with various embodiments described herein. In various embodiments, the machine learning model 300 may include a plurality of layers, including an input layer 302, one or more hidden layers 304, and an output layer 305. For example, in various embodiments, the machine learning model 300 may be a deep learning model (e.g., a neural network), such as a deep neural network (DNN), an artificial neural network (ANN), a convolutional neural network (CNN), a recurrent neural network (RNN), and/or the like, comprising a plurality of layers.

The machine learning model 300 receives its model input at the input layer 302, and the input layer 302 includes a number of neuronal units 310 that may, in some examples, at least approximately correspond to a dimensionality, a size, a partitioning scheme (e.g., a convolutional kernel size), and/or the like of the model input. The data at the input layer 302 is then processed and fed through the one or more hidden layers 304 sequentially until the data reaches its final state at the output layer 306, at which the model output is provided. Similar to the input layer 302, the number of neuronal units 310 at the output layer 306 may at least approximately correspond to a dimensionality, a size, a partitioning scheme, and/or the like of the model output. It should be recognized that, while the illustrated embodiment shows four neuronal units in each of the input layer 302 and the output layer 306, such configuration is non-limiting and for illustrative purposes only—the input layer 302 and the output layer 306 may each have any number of the neuronal units 310 necessary to accommodate the model inputs and model outputs and the function of the machine learning model. Further, the input layer 302 and the output layer 306 may not necessarily comprise the same number of neuronal units 310.

Within the machine learning model 300, data is processed and fed through hidden layers 304 in a layer-wise manner through edges 312 that represent the flow of data from one layer to the next. A hidden layer 304 includes a plurality of neuronal units 310 that are connected via edges 312 to neuronal units 310 of a preceding layer (e.g., the input layer 302, another hidden layer 304) and to neuronal units 310 of a succeeding layer (e.g., the output layer 306, another hidden layer 304). With data flowing within the machine learning model 300 from the input layer 302 to the output layer 306 during the feed-forward or inference operation of the machine learning model 300, the edges 312 may be directional to indicate the directional flow of data through the layers. As demonstrated in FIG. 3, a neuronal unit 310 of a hidden layer 304 may then receive data from multiple (e.g., each) of the neuronal units 310 of the preceding layer, and based at least in part on processing the received data, the neuronal unit 310 provides an output to multiple (e.g., each) of the neuronal units 310 of the succeeding layer. In some example embodiments, at least some of the hidden layers 304 of the machine learning model 300 are fully-connected layers, in which the neuronal units 310 receive data from all of the neuronal units 310 of the preceding layer and provide data to all of the neuronal units 310 of the succeeding layer (as in the illustrated embodiment).

As a neuronal unit 310 of a hidden layer 304 receives data from one or more preceding neuronal units, the neuronal unit 310 is configured to process said data in order to generate an output to be provided to one or more succeeding neuronal units. Abstractly, a neuronal unit 310 then represents various functions and operations that may be performed with some portion of data during operation of the machine learning model 300. In processing, or transforming, the received data, the neuronal unit 310 may use various parameters specific to the neuronal unit 310. In various embodiments, each neuronal unit 310 in a hidden layer 304 is associated with one or more parameters, which may include weight parameters, bias parameters, hyperparameters, and/or the like.

Weight parameters may define how certain data or combination of data received at the associated neuronal unit are weighted, and may represent multiplication factors, scaling factors, and/or the like. In some instances, a neuronal unit 310 may be associated with a weight parameter for each preceding neuronal unit from which it receives data. As such, a weight parameter may be represented or associated with an edge 312 connected to the neuronal unit 310. Accordingly, using the weight parameters, the neuronal unit 310 may be configured to determine a weighted sum of at least a portion of the preceding layer's data.

Meanwhile, bias parameters may represent constants that can offset or bias the data received from the preceding layer. For instance, in some examples, a bias parameter may be added onto a weighted sum of the preceding layer's data, at a given neuronal unit. A neuronal unit 310 may use these weight parameters, bias parameters, and/or the like to transform the preceding layer's unit before, during, and/or after execution some function to generate a neuronal unit output. In some examples, an activation function is used at a neuronal unit 310 with transformed data to generate the neuronal unit output.

As a machine learning model 300 generates its output through feeding forward data through its layers, the action of some neuronal units 310 may have a relatively lower effect or impact compared to other neuronal units 310. That is, different neuronal units 310 at various hidden layers 304 may have different significances and contributions to the final output of the machine learning model 300. As such, in accordance with various example embodiments described herein, neuronal units 310 with relatively low impact may be pruned or removed from the machine learning model 300 without significantly affecting the model output, or the accuracy level thereof. Thus, in various example embodiments, neuronal units 310 are evaluated and are conditionally removed from the machine learning model 300 to form a compressed machine learning model. Further, generating a compressed machine learning model further includes redistributing parameters (e.g., weights, biases) from removed neuronal units to other neuronal units so that the information passing through the hidden layers 304 of the model are preserved. For a given neuronal unit that is removed, its parameters may be redistributed to other neuronal units in the same hidden layer 304, such that the overall information conveyed by the hidden layer 304 may not significantly change as a result of the removal of the given neuronal unit.

Therefore, a machine learning model 300 may generally be defined as a sequential arrangement of trainable layers, as demonstrated in Equation 1. In Equation 1, L represents the total number of layers in the machine learning model 300, and X represents the model input.

$$ℳ ( X ) = {ℒ}_{L} ( {ℒ}_{L - 1} … ( {ℒ}_{2} ( {ℒ}_{1} ( X ) ) ) ) \qquad Equation 1$$

Each layer [symbol] ᵢ of the machine learning model 300 may be a convolutional layer, a recurrent layer, a fully connected layer, and/or the like. In various embodiments, a layer can be generalized according to Equation 2.

$${ℒ}_{i} ( {X}_{i} ) = {σ}_{i} ( {W}_{i} {X}_{i} + {B}_{i} ) = {Y}_{i} \qquad Equation 2$$

In Equation 2, Xᵢ represents the input to the layer [symbol] such that Xᵢ=Yᵢ₋₁ and for i=1 (the first layer), Xᵢ=X. Further, σᵢ represents the activation function of the layer, Wᵢ represents the weight parameters within the layer (e.g., for each neuronal unit 310 of the layer), and Bᵢ represents the bias parameters within the layer (e.g., for each neuronal unit 310 of the layer). Given that the layer [symbol] includes m; number of neuronal units 310 and that the layer [symbol] ᵢ₋₁ includes nᵢ₋₁ number of neuronal units 310, then Xᵢ∈ [symbol] ⁿ^{ᵢ₋₁}^{×1}, Yᵢ∈ [symbol] ^{m}^{ᵢ}^{×1}, Wᵢ∈ [symbol] ^{m}^{ᵢ}^{×n}^{ᵢ₋₁}, and Bᵢ∈ [symbol] ^{m}^{ᵢ}^{×1}, with [symbol] denoting the set of real numbers.

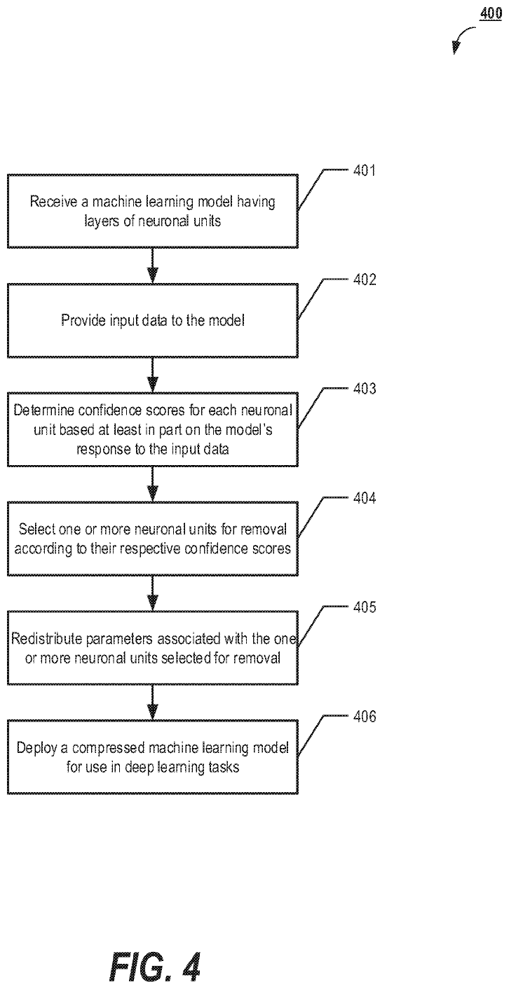

Having now described an illustrative example of a machine learning model 300 that includes a plurality of layers having neuronal units 310, example operations performed for compressing a machine learning model 300 are now discussed. FIG. 4 provides a flowchart for a process 400 including example operations that are performed by the apparatus 200 to compress the machine learning model 300. As discussed, in various embodiments, the process 400 may be performed by a resource-constrained device 106 to compress the machine learning model 300 for its own respective and/or device-specific tasks, and the machine learning model 300 may be compressed in different device-specific manners by different resource-constrained devices 106. In various examples, the process 400 may be performed by a resource-dedicated system 101 that is configured to train the machine learning model 300.

As shown, the process 400 includes operation 401, at which the apparatus 200 includes means, such as one or more processors 202, one or more memories 204, one or more communications circuitry 208, processing circuitry, and/or the like, for receiving the machine learning model 300. An example of the machine learning model 300 is illustrated and described in the context of FIG. 3. In various embodiments, receiving the machine learning model 300 may entail receiving at least a configuration or architecture of the machine learning model 300 (e.g., a number of layers, a number of neuronal units 310 for each layer) and one or more parameters for each neuronal unit 310.

In various example embodiments, the apparatus 200 may receive the machine learning model 300 for compression from a resource-dedicated system 101 and/or a data repository 102. In one or more example embodiments, the apparatus 200 is embodied by an end device in communication with a resource-dedicated system 101 (e.g., a central computer system) and receives the machine learning model 300 via a communication network 105. In other example embodiments, the apparatus 200 may access, retrieve, and/or receive the machine learning model 300 from a data repository 102, which may be an open-source or public repository storing the machine learning model 300 and accessible via the Internet, for example. In various example embodiments, the apparatus 200 may be embodied by an end device and may receive at least a portion of the machine learning model 300 from other end devices.

While the illustrated embodiment illustrates the process 400 including receiving the machine learning model 300, the process 400 may provide model compression for a machine learning model 300 already residing upon the apparatus 200. For example, the apparatus 200 may be pre-loaded, manufactured, shipped, programmed, and/or the like with the machine learning model 300. In any regard, at operation 401, the apparatus 200 is generally in possession of the machine learning model 300.

In various example embodiments, the machine learning model 300 may be pre-trained for one or more deep learning tasks. Such tasks may include but are not limited to classification tasks, recognition tasks, regression and/or prediction tasks, and/or the like. In one or more example embodiments, the machine learning model 300 may be pre-trained by a resource-dedicated system 101 before being provided (e.g., transmitted via a communication network 105) to one or more resource-constrained devices 106.

At operation 402, the apparatus 200 includes means, such as one or more processors 202, one or more memories 204, processing circuitry, and/or the like, for providing input data to the machine learning model 300. In various example embodiments, the input data is provided to the machine learning model 300, and the machine learning model 300 is operated to generate a model output in response to the input data. As discussed, the machine learning model 300 may be pre-trained for one or more deep learning tasks, and thus the machine learning model 300 may generate a model output for its trained function in response to the input data.

In various example embodiments, the input data provided to the machine learning model 300 may be specific to the deep learning tasks for which the machine learning model 300 will be deployed and may be further specific to the resource-constrained device 106 on which the compressed machine learning model will be deployed. As such, the behavior of the machine learning model 300 and its internal transformations of data can be understood directly in its applied context. In various example embodiments, the input data may include IoT data, sensor streams, logs, and/or the like. In various example embodiments in which process 400 is performed by the resource-constrained device 106 that will deploy the compressed machine learning model, improved data security and privacy is provided, as individual devices may use their own data as the input data for their own model compressions and device-specific and/or device-generated data may not be as widely distributed for a centralized model compression. For instance, in various example embodiments, the input data for the machine learning model 300 may be secure data, user-specific data, device-specific data, and/or the like, received, generated and/or stored in the resource-constrained device 106, for example, from one or more sensor streams, usage logs, and/or the like. Similarly, with model compression being individually performed by the resource-constrained devices 106, the model outputs can be similarly contained within respective devices for security and privacy purposes.

Thus, the input data is provided to the machine learning model 300 to obtain model outputs in response. In various embodiments, multiple batches of input data may be provided in order to obtain a requisite volume of model outputs.

At operation 403, the apparatus 200 includes means, such as one or more processors 202, one or more memories 204, processing circuitry, and/or the like, for determining a confidence score for each neuronal unit 310 of the machine learning model 300 responsive to the input data, or based at least in part on the model's response to the input data. That is, at operation 403, the apparatus 200 determines the significance or impact of each neuronal unit 310 of the machine learning model 300 in generating the model output, such significance or impact being quantifiably measured through the confidence scores.

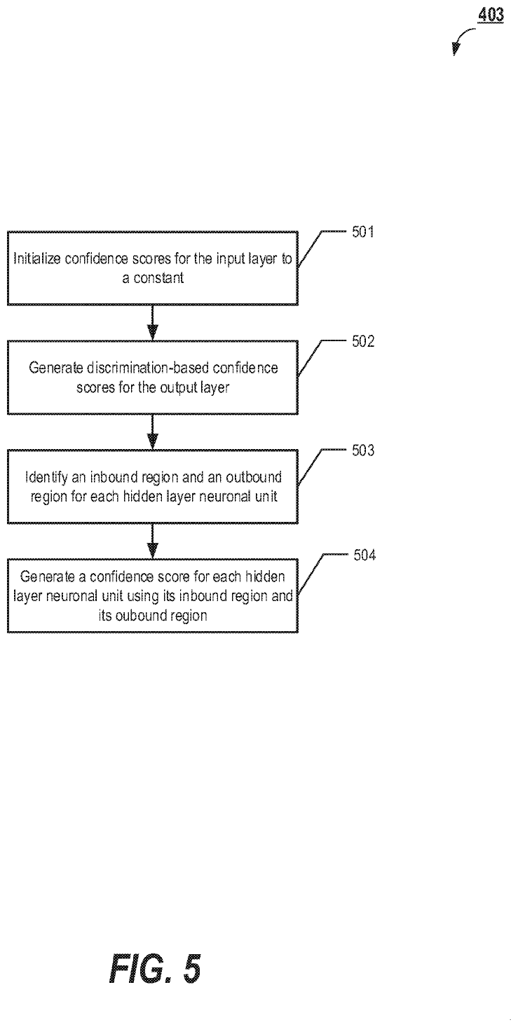

Turning to FIG. 5, example operations performed to determine confidence scores for the neuronal units 310 of the machine learning model 300 are illustrated. At operation 501, the apparatus 200 includes means, such as one or more processors 202, one or more memories 204, processing circuitry, and/or the like, for initializing the confidence scores for the neuronal units 310, at the input layer 302 to a constant. In one or more example embodiments, the confidence scores for the neuronal units 310 at the input layer 302 may be initialized to one. The confidence scores for the input neuronal units being initialized to a constant represents an assumption that all of the input data entering the machine learning model 300 is equally important, at least initially.

At operation 502, the apparatus 200 includes means, such as one or more processors 202, one or more memories 204, processing circuitry, and/or the like, for generating discrimination-based confidence scores for the neuronal units 310 at the output layer 306. In particular, one or more discrimination techniques are performed the model output obtained in response to providing the input data to the machine learning model 300, and confidence scores for the output neuronal units are determined accordingly. In various embodiments, the discrimination techniques that may be performed include infinite feature selection, latent decomposition, principal component analysis, and/or the like, and the discrimination techniques may be performed to determine how well the model output is discriminated from other possible outputs or to determine an accuracy of the model output. For instance, in classification tasks, the discrimination techniques may characterize how well the machine learning model 300 predicts true classes (e.g., with high probability outputs) and how well the machine learning model 300 predicts false classes (e.g., with low probability outputs). Thus, with the discrimination techniques, each output neuronal unit, which may represent a particular class in a classification task, may be assigned with a confidence score representing a discriminatory behavior of the machine learning model 300 for the corresponding class. In regression tasks, the confidence score for the output neuronal unit may be generated using an inverse relationship with a regression error, such that the output neuronal units with minimal error are assigned with higher confidence scores. Accordingly, to generate confidence scores for the output neuronal units, historical ground-truth or labelled data may be used, in various example embodiments.

At operation 503, the apparatus 200 includes means, such as one or more processors 202, one or more memories 204, processing circuitry, and/or the like, for identifying an inbound region and an outbound region for each neuronal unit 310 at each of one or more hidden layers, such as the hidden layer 304 illustrated in FIG. 3. Having generated confidence scores for the neuronal units 310 of the input layer 302 and the output layer 306, confidence scores for the neuronal units 310 of the hidden layers 304 may be generated using an inbound region and an outbound region to characterize and capture a neuronal unit's relationship with the input layer 302 and the output layer 306. That is, each neuronal unit 310 of a hidden layer 304 is influenced to some extent by its preceding one or more layers including the input layer 302 and also propagates its influence to its succeeding one or more layers including the output layer 306. Thus, a confidence score for a hidden layer neuronal unit is generated according to its relationship with other layers of the machine learning model 300.

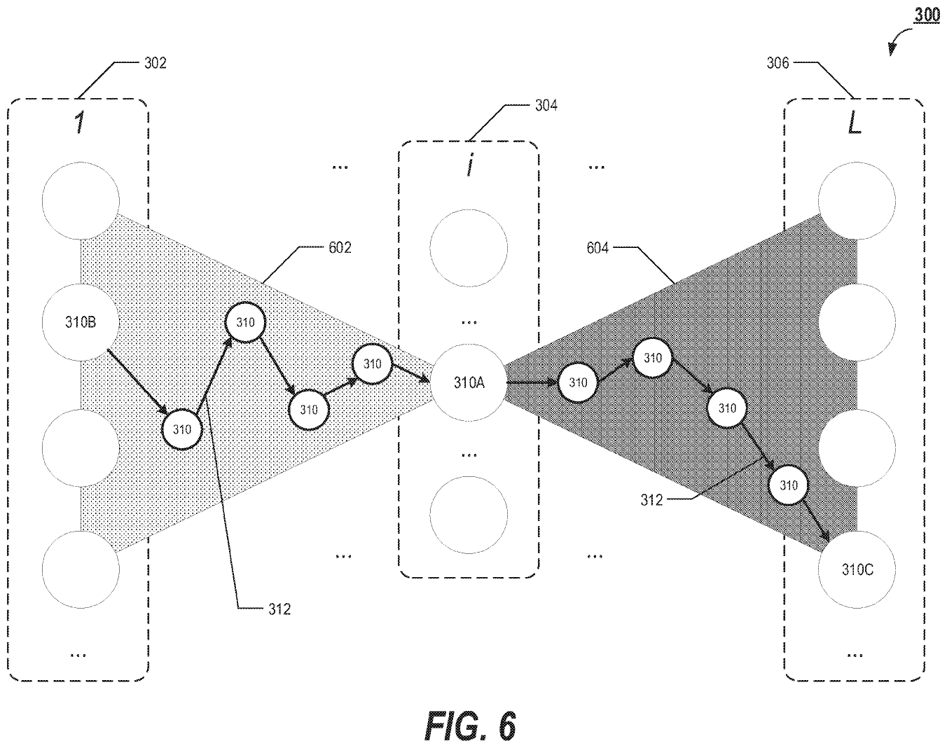

FIG. 6 provides an example diagram of a machine learning model 300, according to various example embodiments, within which an inbound region 602 and an outbound region 604 may be identified for a particular neuronal unit 310A of a hidden layer 304. The inbound region 602 of a hidden layer neuronal unit represents the information that can reach the hidden layer neuronal unit, while the outbound region 604 represents the information that reaches the model output from the hidden layer neuronal unit.

In particular, the inbound region 602 of the hidden layer neuronal unit comprises different feed-forward paths (comprising one or more edges 312) that traverse from the input layer 302 through zero or more preceding hidden layers to the hidden layer neuronal unit. For instance, FIG. 6 illustrates one such example feed-forward path traversing from an input neuronal unit 310B through a number of neuronal units of different hidden layers to reach the particular neuronal unit 310A in the hidden layer 304. This example feed-forward path may belong to the inbound region 602 of the particular neuronal unit 310A. The inbound region 602 for a hidden layer neuronal unit (e.g., unit 310A illustrated in FIG. 6) may include all such paths spanning from any input neuronal unit, such as the input neuronal unit 310B shown in FIG. 6, to the hidden layer neuronal unit.

Meanwhile, the outbound region 604 of a hidden layer neuronal unit comprises all of the different feed-forward paths (comprising one or more edges 312) that traverse from the hidden layer neuronal unit to the output layer 306 and through zero or more succeeding hidden layers. FIG. 6 illustrates an example feed-forward path belonging to the outbound region 604 of the particular neuronal unit 310A, with the example path spanning from the unit 310, through a number of neuronal units of different hidden layers to an output neuronal unit 310C. The outbound region 604 may include many other feed-forward paths spanning similarly to one or more output neuronal units, such as the illustrated output unit 310C.

Thus, identifying the inbound region 602 for a given neuronal unit includes identifying a plurality of edges 312 and related preceding neuronal units which define one or more paths that feed into the given neuronal unit, and identifying an outbound region 604 for the neuronal unit 310 includes identifying a plurality of edges 312 and related succeeding neuronal units which define one or more paths that feed out of the neuronal unit 310. In various example embodiments, the inbound region 602 may be embodied as a set of traversal paths originating from each input neuronal unit to the hidden layer neuronal unit, while the outbound region 604 may be embodied by a set of traversal paths originating from the hidden layer neuronal unit to each output neuronal unit. Given that each traversal path may span through a number of layers, the inbound region 602 may be defined in matrix forms, in some example embodiments.

Returning to FIG. 5, at operation 504, the apparatus 200 includes means, such as one or more processors 202, one or more memories 204, processing circuitry, and/or the like, for generating a confidence score for each neuronal unit 310 of each hidden layer 304 using its inbound region 602 and its outbound region 604. In particular, the confidence score for a hidden layer neuronal unit is generated based at least in part on generating an inbound score and an outbound score respectively corresponding to the inbound region 602 and the outbound region 604 of the hidden layer neuronal unit. Through generating an inbound score and an outbound score, the overall confidence score that represents the overall importance of a neuronal unit 310 is driven by the importance of the various paths feeding into and out of the neuronal unit 310.

In various example embodiments, the inbound score that is associated with the inbound region 602 of a hidden layer neuronal unit (e.g., unit 310A illustrated in FIG. 6) may be generated according to parameters belonging to neuronal units spanned by the various traversal paths of the inbound region 602. With the example traversal path illustrated in FIG. 6 belonging to the inbound region 602, for example, weight parameters for each of the neuronal units spanned by the example traversal path may be used to generate the inbound score. Further, the inbound score may be generated based at least in part on the confidence score for the input neuronal units belonging to the inbound region 602.

According to one or more example embodiments, the inbound scores Nᵢ^{is} for a hidden layer i can be generated with Equation 3.

$${N}_{i}^{is} = {N}_{i - 1}^{is} \cdot {W}_{i}^{+} = [ {N}_{i - 1 , 1}^{is} … {N}_{i - 1 , {n}_{i}}^{is} ] [ \begin{matrix}{W}_{i , 1 , 1}^{+} & … & {W}_{i , 1 , {m}_{i}}^{+} \\ ⋮ & ⋱ & ⋮ \\ {W}_{i , {n}_{i} , 1}^{+} & … & {W}_{i , {n}_{i} , {m}_{i}}^{+}\end{matrix} ] \qquad Equation 3$$

In Equation 3, Wᵢ⁺ represents absolute positive weights of a weight matrix Wᵢ for the weight parameters at the i^{th} layer. For instance, in some examples, the parameters (including weights and biases) found within the machine learning model 300 may generally follow Gaussian distributions centered around zero. Thus, some parameters may contribute a relatively negligible amount to the overall model output and can even introduce noise. Furthermore, two connections within the network (e.g., two edges 312) may have the same weight parameter but may differ in the degree of contribution to the final network output (in terms of sign or polarity of the weights). As such, absolute positive weights may be used to generate confidence scores, in various embodiments.

From Equation 3, the inbound scores Nᵢ^{is} for the i^{th} hidden layer can be expanded or re-defined in Equation 4 to explicitly show that the inbound scores depend upon the confidence scores of the input layer 302 (represented by I^{S}).

$${N}_{i}^{is} = {I}^{s} ( {W}_{1}^{+} ( {W}_{2}^{+} … ( {W}_{i}^{+} ) ) ) \qquad Equation 4$$

In one or more example embodiments, the outbound scores Nᵢ^{OS} for the hidden layer i can be generated with Equation 5.

$${N}_{i}^{os} = {W}_{i + 1}^{+} \cdot {N}_{i + 1}^{os} = [ \begin{matrix}{W}_{i , 1 , 1}^{+} \times {N}_{i + 1 , 1}^{os} + … + {W}_{i , {m}_{i} , 1}^{+} \times {N}_{i + 1 , 1}^{os} \\ ⋮ \\ {W}_{i , 1 , {n}_{i}}^{+} \times {N}_{i + 1 , {n}_{i}}^{os} + … + {W}_{i , {m}_{i} , {n}_{i}}^{+} \times {N}_{i + 1 , {n}_{i}}^{os}\end{matrix} ] \qquad Equation 5$$

As understood from Equation 5, the outbound scores Nᵢ^{OS} for the hidden layer i depend (recursively) upon the confidence scores of the output layer 306. This can be explicitly shown in Equation 6, with O^{S} representing the confidence scores of the output layer 306.

$${N}_{i}^{os} = ( {W}_{i}^{+} ( {W}_{i + 1}^{+} … ( {W}_{L}^{+} {O}^{s} ) ) ) \qquad Equation 6$$

Thus, with at least the above, both inbound scores and outbound scores can be determined for hidden layer neuronal units, and can be generated in a layer-wise manner. For example, in the above equations and for a given i^{th} layer, Nᵢ^{is}∈ [symbol] ^{1×m}^{ᵢ} and Nᵢ^{OS}∈ [symbol] ^{1×m}^{ᵢ} for mᵢ number of neuronal units, with [symbol] denoting the set of complex numbers. In one or more example embodiments, in the above equations and for a given i^{th} layer, Nᵢ^{iS}∈ [symbol] ^{1×m}^{ᵢ} and Nᵢ^{OS}∈ [symbol] ^{1×m}^{ᵢ} for mᵢ number of neuronal units, with [symbol] denoting the set of real numbers.

With the inbound scores and the outbound scores, the overall confidence score for a hidden layer neuronal unit can then be generated to represent the overall importance of the hidden layer neuronal unit. In various embodiments, the inbound score and the outbound score can be weighted relative to each other when generating the overall confidence score, and in some examples, this weighting may be based at least in part on the relative position of the hidden layer in question (e.g., its proximity to the input layer 302 and the output layer 306). In one or more example embodiments, the overall confidence score Nᵢ^{S} for neuronal units for a given i^{th} hidden layer can be generated according to Equation 7, with a representing the weighting of the inbound score and the outbound score. In some examples, a can be set to a default value, such as 0.5.

$${N}_{i}^{s} = α {N}_{i}^{is} + ( 1 - α ) {N}_{i}^{os} = [ \begin{matrix}α {N}_{i , 1}^{is} + ( 1 - α ) {N}_{i , 1}^{os} \\ ⋮ \\ α {N}_{i , {m}_{i}}^{is} + ( 1 - α ) {N}_{i , {m}_{i}}^{os}\end{matrix} ] \qquad Equation 7$$

Returning to FIG. 4, the apparatus 200 accordingly determines confidence scores indicative of contribution, significance, and/or impact of the neuronal units 310, of the machine learning model 300 at operation 403. At operation 404, the apparatus 200 includes means, such as one or more processors 202, one or more memories 204, processing circuitry, and/or the like, for selecting one or more neuronal units for removal from the machine learning model 300. The selection of neuronal units is with respect to the confidence scores associated with the neuronal units, such that the neuronal units with relatively lower contribution or significance, when compared to other neuronal units, are selected for removal and pruning. With removal of pruning of the selected neuronal units, a compressed machine learning model of the machine learning model 300 comprises a reduced volume of data and can be executed with fewer operations, in various examples.

In various example embodiments, selection of neuronal units for removal may involve one or more configurable thresholds with respect to the confidence scores of the hidden layer neuronal units (e.g., Nᵢ^{S}). In one or more example embodiments, a configurable threshold may be a percentage pₓ of neuronal units with the lowest confidence scores within a given hidden layer. That is, for each hidden layer 304, the neuronal units may be ranked according to their confidence scores, and a percentage pₓ of neuronal units having lower confidence scores compared to other neuronal units may be selected for removal. In one or more example embodiments, a configurable threshold may be a particular value, and neuronal units having confidence scores below the particular value may be selected for removal, for example. In one or more example embodiments, a configurable threshold may be a constant number (as opposed to a percentage) of neuronal units to remove from each hidden layer. It will be understood that the configurable thresholds used to select neuronal units for removal may include but are not limited to any of and combinations of the such identified above.

In various example embodiments, a configurable threshold (e.g., percentage pₓ) is defined specific to a system or device on which the compressed machine learning model will be deployed. As such, removal of neuronal units from the machine learning model 300 may be customized to a device's needs. For example, a configurable threshold is defined and may be dynamically variable (e.g., proportional, inversely proportional) with resource constraints or resource allocations of a resource-constrained device 106 that will implement and use the compressed machine learning model. Accordingly, if the resource-constrained device 106 is associated with significant resource constraints, a greater number of neuronal units may be removed, for example, compared to another device with relatively lighter resource constraints. It will be appreciated that, in certain embodiments in which the resource-constrained device 106 performs the model compression itself (e.g., via process 400), resource information specific to the resource-constrained device 106 need not be distributed for model compression.

In various example embodiments, the selection of neuronal units in a given hidden layer for removal may comprise generating a binary vector Mᵢ∈{0,1}^{1×m}^{ᵢ} from the confidence scores to indicate neuronal unit removal.

Thus, a subset of neuronal units of the machine learning model 300 are selected for removal and may be removed from the machine learning model 300 to form a compressed machine learning model, at operation 404.

At operation 405, the apparatus 200 includes means, such as one or more processors 202, one or more memories 204, processing circuitry, and/or the like, for redistributing parameters associated with the one or more neuronal units selected for removal. As discussed, the redistribution of the parameters from the removed neuronal units to other neuronal units prevents or minimizes accuracy loss from the machine learning model 300 to the compressed machine learning model, as the information within the machine learning model 300 is preserved. With the redistribution of the parameters, re-training of the compressed machine learning model is not necessary; that is, for example, the compressed machine learning model may retain acceptable levels of accuracy for its deep learning tasks.

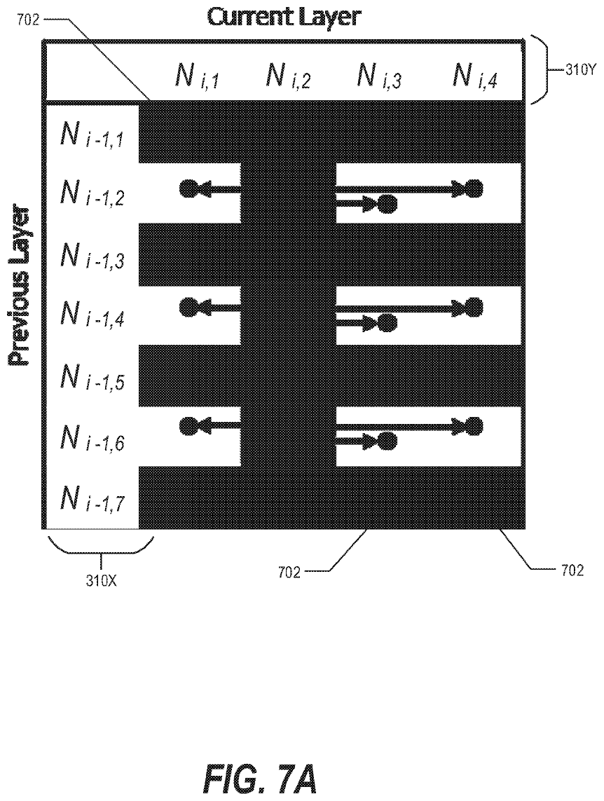

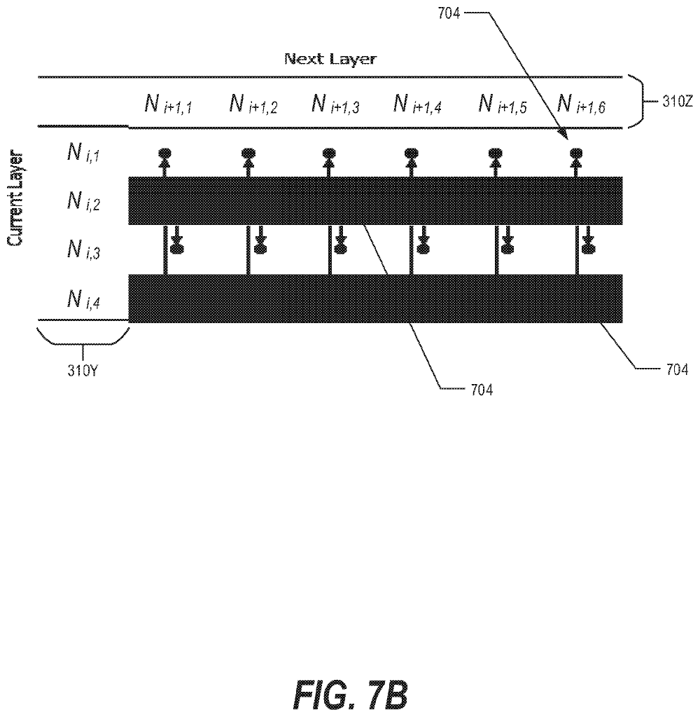

FIG. 7A illustrates an example diagram demonstrating redistribution of parameters to other neuronal units. The example diagram is illustrated in a tabular format to appropriately indicate weight parameters 702 corresponding to connections (e.g., edges 312) between neuronal units 310Y of a given hidden layer (“Current Layer”) and neuronal units 310X of a preceding layer (“Previous Layer”). In the illustrated embodiment, for example, the neuronal unit indicated by N_{i,2} may be removed from the given hidden layer. As such, with the removal of the N_{i,2} neuronal unit, its parameters—or the weight parameters 702 between the connections {N_{i,2}, N_{i-1,1}}, {N_{i,2}, N_{i-1,2}}, {N_{i,2}, N_{i-1,3}} and so on—are redistributed to other neuronal units in the given hidden layer, in various embodiments. For instance, the weight parameters 702 for the connection between N_{i,2} and N_{i-1,1} may be redistributed to the connections {N_{i,1}, N_{i-1,1}}, {N_{i,3}, N_{i-1,1}}, {N_{i,4}, N_{i-1,1}}.

FIG. 7B illustrates another example diagram demonstrating redistribution of parameters to other neuronal units. While FIG. 7A demonstrated redistribution of weight parameters 702 for connections or edges 312 between a given hidden layer (“Current Layer”) and a preceding layer (“Previous Layer”), FIG. 7B illustrates redistribution of weight parameters 704 for connections or edges 312 between the given hidden layer (“Current Layer”) and a succeeding layer (“Next Layer”). In various embodiments, parameter redistribution in both directions (e.g., with the preceding layer and with the succeeding layer) can be performed for a given hidden layer having neuronal units for pruning.

As with the illustrated embodiment of FIG. 7A, the neuronal unit indicated by N_{i,2} may be removed from the Current Layer, and as such, weight parameters 704 that previously were associated with connections between the N_{i,2} neuronal unit and each of the six neuronal units of the Next Layer are redistributed to other connections spanning from the N_{i,1} neuronal unit, the N_{i,3} neuronal unit, and the N_{i,4} neuronal unit, respectively, to each of the six neuronal units of the Next Layer. As discussed, in various embodiments, both weight parameters 702 shown in FIG. 7A for preceding connections and weight parameters 704 shown in FIG. 7B for succeeding connections are redistributed with pruning of a given neuronal unit, such as the N_{i,2} neuronal unit.

In various embodiments, the magnitude or degree of the redistribution to other connections is based at least in part on the existing weights and parameters at the other connections. For instance, the connection with the larger weight parameter in the given hidden layer may receive a proportional amount of the weight parameter 702 from the removed connection. While this description is provided in the explicit context of weight parameters 702, other parameters including bias parameters, hyperparameters, and/or the like may additionally or alternatively be redistributed.

In one or more example embodiments, the parameters (e.g., weight parameters) of the removed neuronal units (e.g., the N_{i,2} neuronal unit of the illustrated embodiments of FIGS. 7A and 7B) are redistributed proportionally to parameters that remain and are associated with non-removed neuronal units, or neuronal units determined to have at least a threshold contribution, significance, and/or impact on the model's function. This redistribution can be defined according to Equation 8, in example embodiments.

$${W}_{i}^{′} = {W}_{i} + {W}_{j} ( \frac{{W}_{i}}{{\sum }_{k = 0 , k \neq j}^{n} {W}_{k}} ) , \\ and {B}_{i}^{′} = {B}_{i} + {B}_{j} ( \frac{{B}_{i}}{{\sum }_{k = 0 , k \neq j}^{n} {B}_{k}} ) \qquad Equation 8$$

In Equation 8, Wᵢ and Bᵢ represent the previous parameters (e.g., weight and bias parameters) of the non-pruned neuronal units before redistribution, Wⱼ and Bⱼ represent the parameters associated with one or more pruned neuronal units, and Wₖ and Bₖ identify the non-pruned or remaining neuronal units. With Equation 8, the new weights and bias, Wᵢ′ and Bₖ′, of the non-pruned or remaining neuronal units can be generated.

Thus, with the removal of the neuronal units having low contribution and redistribution of the parameters belonging to the removed neuronal units to the other neuronal units, a compressed machine learning model can be formed while minimizing loss of accuracy and without requiring re-training, in various embodiments.

Returning to FIG. 4, at operation 406, the apparatus 200 includes means, such as one or more processors 202, one or more memories 204, processing circuitry, and/or the like, for deploying a compressed machine learning model for use in one or more deep learning tasks. In various example embodiments, the compressed machine learning model is deployed at a system or device whose input data and resource information were used for the model compression. For example, in one or more embodiments, a resource-constrained device 106 generates the compressed machine learning model and deploys the compressed machine learning model for its own use. In various example embodiments, deployment of the compressed machine learning model may include integrating the compressed machine learning model into one or more pipelines for the deep learning tasks, and generally, the compressed machine learning model may be deployed and configured to generate its model output responsive to input data collected by the system or device.

Therefore, as described above, operations, methods, apparatuses, and computer program products are disclosed for compressing machine learning models, for example, for improved usage and efficiency with respect to computational resources. Various example embodiments provide compressed machine learning models that may not necessarily require re-training in order to provide an approximately similar level of accuracy as the original machine learning model. Various example embodiments described herein provide technical advantages, with compressed machine learning models having reduced size compared to their parent models. For instance, a compressed machine learning model can be executed in less time with fewer operations (e.g., floating point operations) leading to improved operational efficiency and throughput at resource-constrained devices 106, in various embodiments. Further, less processing bandwidth may be required for running compressed machine learning models, and lower power consumption may also result from model compression.

FIG. 4 and FIG. 5 illustrate flowcharts depicting operations according to various example embodiments of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of an apparatus employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the present disclosure set forth herein will come to mind to one skilled in the art to which present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-55. (canceled)

56. An apparatus comprising:
at least one processor; and
at least one memory storing instructions that, when executed by the at least one processor, cause the apparatus at least to:
provide input data for one or more deep learning tasks to a machine learning model comprising a plurality of neuronal units associated with at least one respective parameter;
determine respective confidence scores for the plurality of the neuronal units responsive to the input data; and
generate a compressed machine learning model of the machine learning model based at least in part on redistributing the respective parameters associated with a first subset of the neuronal units to a second subset of the neuronal units, the first subset of the neuronal units being selected according to their respective confidence scores.

57. The apparatus of claim 56, wherein the compressed machine learning model is generated further based at least in part on removing the first subset of the neuronal units from the machine learning model.

58. The apparatus of claim 56, wherein a magnitude by which the respective parameters associated with the first subset are redistributed to the neuronal units of the second subset is based at least in part on the respective parameters associated with the second subset.

59. The apparatus of claim 56, wherein the first subset includes neuronal units selected from one or more hidden layers of the machine learning model and having confidence scores satisfying a configurable threshold.

60. The apparatus of claim 59, wherein the configurable threshold is configured based at least in part on an amount of computing resources associated with the at least one processor.

61. The apparatus of claim 56, wherein the second subset comprises at least one neuronal unit belonging to a hidden layer of the machine learning model to which at least one neuronal unit of the first subset also belongs.

62. The apparatus of claim 56, wherein the determination of the respective confidence scores for the plurality of the neuronal units, for a neuronal unit belonging to a hidden layer of the machine learning model, further comprises:
identify an inbound region and an outbound region for the neuronal unit, the inbound region mapping to an input layer of the machine learning model and the outbound region mapping to an output layer of the machine learning model,
determine an inbound confidence score for the neuronal unit using the inbound region and determine an outbound confidence score for the neuronal unit using the outbound region, and
use the inbound confidence score and the outbound confidence score to form a confidence score for the neuronal unit.

63. The apparatus of claim 62, wherein the inbound confidence score is determined according to the respective parameters associated with neuronal units within the inbound region and respective confidence scores for neuronal units within the input layer, and wherein the outbound confidence score is determined according to the respective parameters associated with neuronal units within the outbound region and respective confidence scores for neuronal units within the output layer.

64. The apparatus of claim 56, wherein the determination of the respective confidence scores for the plurality of the neuronal units further comprises:
initialize the confidence score for a plurality of neuronal units belonging to an input layer of the machine learning model to a constant value, and
determine the confidence score for a plurality of neuronal units belonging to an output layer of the machine learning model based at least in part on generating a discrimination output for a plurality of values at the plurality of neuronal units belonging to the output layer in response to the input data.

65. The apparatus of claim 56, wherein the input data includes data generated by the apparatus.

66. The apparatus of claim 56, wherein the at least one memory storing the instructions that, when executed by the at least one processor, further cause the apparatus to:
deploy the compressed machine learning model for use in performing the one or more deep learning tasks.

67. The apparatus of claim 56, wherein the machine learning model is pre-trained.

68. The apparatus of claim 56, wherein the machine learning model is a partially-compressed model, and wherein the input data is training data for the machine learning model.

69. The apparatus of claim 56, wherein the at least one respective parameter associated with a neuronal unit includes a weight for the neuronal unit and/or a bias for the neuronal unit.

70. A method comprising:
providing input data for the one or more deep learning tasks to a machine learning model comprising a plurality of neuronal units associated with at least one respective parameter;
determining respective confidence scores for the plurality of the neuronal units responsive to the input data; and
generating a compressed machine learning model of the machine learning model based at least in part on redistributing the respective parameters associated with a first subset of the neuronal units to a second subset of the neuronal units, the first subset of the neuronal units being selected according to their respective confidence scores.

71. The method of claim 70, wherein the compressed machine learning model is generated further based at least in part on removing the first subset of the neuronal units from the machine learning model.

72. The method of claim 70, wherein a magnitude by which the respective parameters associated with the first subset are redistributed to the neuronal units of the second subset is based at least in part on the respective parameters associated with the second subset.

73. The method of claim 70, wherein the first subset includes neuronal units selected from one or more hidden layers of the machine learning model and having confidence scores satisfying a configurable threshold.

74. The method of claim 70, wherein the second subset comprises at least one neuronal unit belonging to a hidden layer of the machine learning model to which at least one neuronal unit of the first subset also belongs.

75. A non-transitory computer readable medium comprising program instructions that, when executed by an apparatus, cause the apparatus to perform at least the following:
provide input data for the one or more deep learning tasks to a machine learning model comprising a plurality of neuronal units associated with at least one respective parameter;
determine respective confidence scores for the plurality of the neuronal units responsive to the input data; and
generate a compressed machine learning model of the machine learning model based at least in part on redistributing the respective parameters associated with a first subset of the neuronal units to a second subset of the neuronal units, the first subset of the neuronal units being selected according to their respective confidence scores.
